(19) United States
(12) Patent Application Publication
(10) Pub. No.: US 2013/0110596 A1
(43) Pub. Date: May 2, 2013

(54) FOREIGN LANGUAGE INCENTIVE STRUCTURE FOR CROWDSOURCED RESEARCH

(71) Applicant: Cheryl Anne Milone, New York, NY (US)

(72) Inventor: Cheryl Anne Milone, New York, NY (US)

(73) Assignee: Article One Partners Holdings, New York, NY (US)

(21) Appl. No.: 13/656,474

(22) Filed: Oct. 19, 2012

Related U.S. Application Data
(60) Provisional application No. 61/548,860, filed on Oct. 19, 2011.

(51) Int. Cl. G06Q 30/02

(52) U.S. Cl. CPC G06Q 30/0208
USPC 705/14.11

(57) ABSTRACT

Crowdsourced research can be improved by increasing the submissions of solutions in languages other than languages in which a research problem is posed. This may be facilitated by providing incentives for translators to participate in translating the research problem, to solve research problems and to provide them with incentives for submitting solutions in the languages in which they translated the research problem or other language that is different from the language in which a research problem is posed.

### CLAIM OF PRIORITY

This patent application claims the benefit of priority to U.S. Provisional Patent Application Ser. No. 61/548,860, filed on Oct. 19, 2011, which is hereby incorporated by reference herein in its entirety.

### FIELD OF THE INVENTION

The present invention is directed to crowdsourcing.

### BACKGROUND OF THE INVENTION

As the use of the world-wide web by persons from around the globe continues to increase, more and more businesses are turning to crowdsourcing as means of improving their offerings and their bottom lines. One particularly beneficial application of crowdsourcing is finding solutions for research problems. However as many companies know, when they turn to crowdsourcing for solutions to research problems, participation is biased in favor of those who can read proficiently the language in which a research problem is posed, and when evidence is requested, the evidence that is received is most frequently in the language in which the request was posed. Thus in a crowdsource platform with a research element, there is a challenge of how to incentivize foreign language speakers to conduct research in their native languages.

To date, the primary approach to increase participation by foreign language speakers has been to have the site translated into foreign languages so that foreign language speakers can access the site in their native languages and execute the objectives on the site in those foreign languages. Search engine optimization (SEO) has also been applied so that the primary language on the web page is customized for the foreign language of each given locale.

Additionally, platforms have arisen where the community that uses the website, particularly foreign language users, is invited to translate the website in order for the site to be available in their native languages. This gives the translator a stakeholder position as a member of the community in that foreign locale and pride of ownership over the site in that language. This work of translation by the community can either be paid or unpaid. For those members that are paid, the translator typically receives payment of the translated text on a word-by-word basis, or on a project basis.

Where the website includes functionality or attempts a business model other than translations, the use of traditional translation approaches has been separate, and therefore has not necessarily met the objective of the website i.e., solving the research problem. Thus, to date there has been an unacceptably low level of participation by translators in crowdsourced research problems.

### SUMMARY OF INVENTION

The present invention is directed to systems, methods, and computer program products for providing foreign language incentive structures for crowdsourced research. Through the use of the various embodiments of the present invention, one can incentivize greater participation in research projects by persons who are non-native speakers of the language in which a research problem is posed and have a greater likelihood of receipt of solutions in a language other than the language in which the research problem is posed. Solutions to the research problem, can be, for example, prior art that anticipates or can be used to render obvious claims of a patent. Thus, the present invention provides traditional translation as a trigger for the translator to perform the functionality of the main objective of the website.

According to a first embodiment, the present invention is directed to a system for incentivizing translation of a crowdsourced research problem. The system comprises at least one processor, wherein the processor is operably coupled to a computer program product with an offering module presenting a research problem over a network in a first language, wherein the computer program product comprises: (a) a receipt of translation module that when executed receives data from a translator, (that may for example be stored in a non-transitory medium) indicating an interest in translating at least one word of the research problem into a second language, wherein the receipt of translation module offers the translator a submission option of providing a submission of a response to the research problem in the second or other language that is different from the first language; (b) a receipt of submission module, wherein the receipt of submission module can be configured to receive a submission from the translator when the submission option is selected; (c) a payment for submission module, wherein the payment for submission module can be configured to compensate the translator a first compensation amount for the submission if the submission is the first submission in the second language and is relevant to the research problem, but does not alone or in combination with other information solve the research problem; and to compensate the translator a second compensation amount for the submission if the submission alone or in combination with other information solves the research problem; and (d) a payment for translation module, wherein the payment for translation module can be configured to compensate the translator for the translation.

According to a second embodiment, the present invention is directed to a system for incentivizing translation of a crowdsourced research problem. The system comprises at least one processor, wherein the processor is operably coupled to a computer program product, wherein the computer program product comprises: (a) an offering module, wherein the offering module presents a research problem over a network in a first language; (b) a receipt of translation module that when executed receives data from a translator, wherein the data indicates an interest in translating at least one word of the research problem into a second language, wherein the receipt of translation module offers the translator a submission option of providing a submission of a response to the research problem in the second language or other language that is different from the first language and a first option to translate additional words of the research problem, a second option of providing a submission of a response to the research problem, and a third option of exiting the receipt of translation module; (c) a receipt of submission module, wherein the receipt of submission module can be configured to receive a submission from the translator when the second option is selected; (d) a payment for translation module, wherein the payment for translation module can be configured to compensate the translator for the translation; and (e) a payment for submission module, wherein the payment for submission module can be configured to compensate the translator a first compensation amount for the submission if the submission is the first submission in the second language and is relevant to the research problem, but does not alone or in combination with other information solve the research problem; and to compensate the translator a second compensation amount for the submission if the submission alone or in combination with other information solves the research problem.

According to a third embodiment, the present invention provides a method for incentivizing a person to participate in solving a crowdsourced research problem posted in a first language on a network. The method comprises: (a) posting a request that the crowdsourced research problem be translated into at least one other language; (b) providing a translator with the opportunity to translate the research problem during a translation session into a second language, wherein the translator can submit a translation of one or more words of the research problem into the second language; (c) upon receipt of the one or more words in the second language, offering the researcher a submission option of providing a submission in response to the research problem; and (d) compensating the translator for the submission at a first compensation amount if the submission is in the second language and is relevant to the research problem and compensating the translator at a second compensation amount if the submission, alone or in combination with other submissions solves the research problem.

According to a third embodiment, the present invention provides a method for incentivizing a person to participate in solving a crowdsourced research problem posted in a first language on a network. The method comprises: (a) posting a request that the crowdsourced research problem be translated into at least one other language; (b) providing a translator with the opportunity to translate the research problem during a translation session into a second language, wherein the translator can submit a translation of one or more words of the research problem into the second language; (c) upon receipt of the one or more words in the second language, offering the researcher a submission option of providing a submission in response to the research problem; and (d) compensating the translator for the submission at a first compensation amount if the submission is in the second language and is relevant to the research problem and compensating the translator at a second compensation amount if the submission, alone or in combination with other submissions solves the research problem.

The various embodiments of the present invention provide incentives for foreign translation by translators that integrate the translation exercise into the purpose of the website and thus provide an added revenue opportunity for translators to select when translating on this platform as compared to other translating opportunities. After the translator completes the translation of a search or key terms of a search on the a platform, whether paid or unpaid, the translator may then be presented with an opportunity to make use of the translation or translated key terms to conduct a search in the translated language, which may for example be the translator's native language. The search may be done in databases provided by the website and/or other databases.

As persons of ordinary skill in the art will recognize, the translator, by executing the translation project increases his or her chances of successfully completing the search because in performing the translation function, the translator has learned about the research project. The ability to include persons with translation skills in solving crowdsourced research problem may be particularly advantageous because of their vocabulary and linguistic skills. Furthermore, the translator has an advantage over other community members in examining the search by virtue of having translated it and being an early entrant, and thus the translator has a higher chance of being successful.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example method embodiment for incentivizing a person to participate in solving a crowd sourced research problem posted in a first language on a network; and

FIG. 3 illustrates an exemplary embodiment of a research problem include a translation reward.

### DETAILED DESCRIPTION

The present invention is directed to systems, methods, and computer program products that may provide an incentive structure for participation in solving crowdsourced research problems. Through the use of these technologies, one may facilitate the number and/or quality of submissions or proposed solutions to a research problem. These technologies may be integrated as parts of a machine and/or cause the transformation of data that is stored in a non-transitory data file.

According to a first embodiment, the present invention provides a system for incentivizing translation of a crowdsourced research problem. A “crowdsourced” research problem is a research problem that is made available to a plurality of persons who are invited to submit solutions to the research problem. The plurality of persons may obtain access to the research problem by, for example, visiting a publicly accessible website over a network. If the entity that poses the research problem wishes to limit access, the website may for example be password protected. In some embodiments, the system may send notice to persons who may have an interest in the research problem or be able to solve it in order to alert them to existence of the research problem.

The system comprises at least one processor, and the processor is operably coupled to a computer program product. A “computer program product” is a set of instructions that may be stored on a hard drive, disk, thumb drive or in a cloud that when executed causes a series of steps to be performed. Typically, the instructions are written and stored in a computer code. The computer program product may have an offering module that presents a research problem over a network in a first language (e.g., English). The offering module may cause the research problem to be displayed over a network, and the problem may for example, be displayed on a web site. A “research problem,” for example, may be a request for information that answers a question, or requests a document that discloses certain information, e.g., discloses information that can anticipate or render obvious claims of a patent.

The computer program product also comprises a receipt of translation module, a receipt of submission module, a payment for submission module, and a payment for translation module. Each of the modules may be operably coupled with one or more other modules. By being operably coupled, the various modules may be able to communicate with each other to carry out their intended purposes.

The receipt of translation module, when executed, receives from a translator, data indicating an interest in translating at least one word of the research problem into a second language. A “translator” is any person who is capable of reviewing words in one language and providing words in another language with the same or similar meaning. The translator may or may not make use of dictionaries or databases deciding on the words to submit. The data may be set electronically in a form that the system can process. In one embodiment the translator may click on an icon on a website that indicates a desire to translate. By clicking on the icon, the translator may be presented with an electronic form that request information about the translator. The receipt of translation module may also offer the translator a submission option of providing a submission of a translation into the second or other languages than the first language. The receipt of translation module may provide the translator with a list of languages in for example the form of a drop down menu that allows the translator to select into which language the research problem will be translated. This module may be configured to receive a complete translation of the research problem or a translation of only certain terms. These select terms maybe referred to as key terms and may reflect what the poser of the research problem deems to be important. In some embodiments, the key terms are highlighted, by e.g., one or more of underlining, bold face, italics, change in size, change in color, or change in font style. In some embodiments, the system chooses whether a complete translation or a translation of only key terms or both may be submitted, and in other or the same embodiments, the translator may be permitted to make these choices.

As noted above, the receipt of submission module can be configured to receive a submission from the translator when the submission option is selected. The submission may for example be in the form of a txt, WORD, PDF, JPEG, or other form that the system can be configured to receive. It may also be configured to allow the person submitting the solution to indicate the language, and/or the system may check or verify the language, by converting the submission to a searchable form if necessary, and automatically reviewing the text for indicia of languages.

The payment for submission module can be configured to compensate the translator a first compensation amount for the submission if the submission is the first submission in the second language and is relevant to the research problem, but does not alone or in combination with other information solve the research problem; and to compensate the translator a second compensation amount for the submission if the submission alone or in combination with other information solves the research problem. Thus, the translator need not solve the problem to obtain the benefits of the invention. The terms “compensation” and “payment” include for example the transfer of money and/or reward points.

The payment for translation module may compensate the translator for the translation. This may be on a strict per word basis, only for certain words that the poser deems to be important weighted and/or on a project basis.

According to a second embodiment, the present invention provides a system for incentivizing translation of a crowdsourced research problem. This system comprises at least one processor, wherein the processor is operably coupled to a computer program product. The computer program product comprises an offering module, a receipt of translation module, a receipt of submission module, a payment for translation module and a payment for submission module.

The offering module presents a research problem over a network in a first language. As with the first embodiment, additionally or alternatively, the offering module may identify one or more terms within the research problem as key terms.

The receipt of translation module can be configured to receive from a translator, data that indicates an interest in translating at least one word of the research problem into a second language. The receipt of translation module may also offer the translator a submission option, which permits the translator to submit a response to the research problem in the second or in another language that is different from the first language. The receipt of translation module may make this offer, by for example providing a link to a web page that can be configured to receive a submission. In some embodiments this module offers: (i) a first option to translate additional words of said research problem; (ii) a second option of providing a submission of a response to the research problem, and (iii) a third option of exiting the receipt of translation module.

The receipt of submission module may be configured to receive a submission from said translator when said second option is selected, and it may be located within the receipt of translation module or as a separate stand alone module.

The payment for translation module may be configured to compensate the translator for said translation. Alternatively or additionally, the payment for translation module may compensate the translator only for translation of key terms. This payment may, for example, be in the form of money, reward points or any other form of payment.

In some embodiments, the payment for submission module can be configured to compensate the translator with a first compensation amount for the submission, if the submission is the first submission in the second language and is relevant to the research problem, but does not alone or in combination with other information solve the research problem; and to compensate the translator a second compensation amount for the submission if the submission alone or in combination with other information solves the research problem. The payment for submission may comprise money, reward points, or any other form of payment.

The system may further comprise a display module that when executed causes the research problem to be displayed in the second language over a network. The display in the second language may be in addition to or instead of the display in the first language. Thus, the result of the translation by the translator may be accessible to other viewers. This may be immediately after translation or after delay, e.g., one day or one week to give the translator a head start. By delaying the posting of the translation, the system can produce a defined time that is the head start for the translator. Additionally, the system may allow multiple translators to translate into the same language or allow only the first translator to do so. Furthermore, the system may allow the subsequent persons to comment on the quality of translation, and to publicly post those comments or to submit them confidentially to the poser of the research problem.

In some embodiments the research problem may request references that alone or in combination with other references invalidate at least one patent claim. Furthermore, the system may ask the translator to identify relevant parts of the reference, and optionally to provide a translation of the key terms or the entire submission document into the first language.

By way of further non-limiting examples, a translator may receive an intermediate reward for his or her initial submission of translated documents, or the first set of submissions that are of quality in the translator's native language.

In each of the embodiments, the network may either be publicly accessible or may be limited access to the site.

A third embodiment provides a method for incentivizing a person to participate in solving a crowdsourced research problem posted in a first language on a network. The method comprises: (a) posting a request that the crowdsourced research problem be translated into at least one other language; (b) providing a translator with the opportunity to translate the research problem during a translation session into a second language, wherein the translator can submit a translation of one or more words of the research problem into the second language; (c) upon receipt of the one or more words in the second language, offering the researcher a submission option of providing a submission in response to the research problem; and (d) compensating the translator for the submission at a first compensation amount if the submission is in the second language and is relevant to the research problem and compensating the translator at a second compensation amount if the submission, alone or in combination with other submissions solves the research problem. Each of these modules may further embody the features describe in connection with the other embodiments.

A fourth embodiment provides a method for incentivizing a person to participate in solving a crowdsourced research problem posted in a first language on a network. The method comprises: (a) posting a request that the crowdsourced research problem be translated into at least one other language; (b) providing a translator with the opportunity to translate the research problem during a translation session into a second language, wherein the translator can submit a translation of one or more words of the research problem into the second language; (c) upon receipt of the one or more words in the second language, offering the researcher a submission options of providing a submission in response to the research problem; and (d) compensating the translator for the submission at a first compensation amount if the submission is in the second language and is relevant to the research problem and compensating the translator at a second compensation amount if the submission, alone or in combination with other submissions solves the research problem.

In certain embodiments, when the translator receives a first compensation amount and a second compensation amount submission by a translator, the first compensation amount may be lower than the second compensation amount. In order to track compensation amounts for a translator, the various embodiments of the present invention may create and store a profile for each translator and update the data file in which the profile is stored to keep track of the earned compensation

Through various embodiments, one may expand on a commoditized business (e.g., translation) and add value to it by executing it as part of a larger project where its execution creates additional revenues for the business and advances the development of the larger project.

Thus, the present invention may increase the substantive participation of foreign language speakers as compared to traditional translation business models by providing translators under the historic model with additional translation revenue beyond the traditional payment model. In using translation to increase the chances of a research project being successful based on foreign language speakers being attracted to the project based first on translation, then becoming a stakeholder in the search, the translator may receive a revenue base that is outsized compared to the commoditized nature of translation.

The systems may also contain one or more of an output device, a graphic user interface, and an input device. Any or all of such devices may be operably coupled to the computer and/or database; and used for their intended purposes to carry out the various embodiments of the present invention.

Thus, the systems, methods and computer program products of the various embodiments of the present invention may be implemented through technologies that are now known or that come to be known and that may be appreciated by persons of ordinary skill in the art as being of use in connection with the present invention. For example, the instructions for implementing the above-referenced methods may be embodied in a computer program product and carried out on hardware, software or a combination thereof that permits the development and use of systems that comprise components that are operably coupled to one another.

The various embodiments of the present invention may also be performed by one or more computers that have access to networks or communication devices in order to permit them to access and to interact with the necessary information sources. Thus, in various embodiments, the methods are accomplished through the use of a computer that comprises a central processing unit and one or more input/output devices. The phrase “central processing unit” and the abbreviation “CPU” are used interchangeably and refer to an electronic circuit that can execute a computer program and can accomplish electronic communication through for example, a processor. A processor is the part of a computer that can execute instructions and manipulate data.

The system may have specific software, including a browser that standardizes communication with network servers. These servers may be any devices that are capable of receiving, delivering and sending email messages, text messages and/or other messages that are sent to it. Thus, a server may comprise a storage device, an input device, an output device, a memory device, a processor and a communication interface.

Persons who are interested in utilizing the methods, systems and computer products of the present invention may communicate with the entity (that may be referred to as a provider) or computer that implements the methods through one or more input devices, output devices, and communication interfaces. An input device is any device that may be used to input, to select and/or to manipulate information. By way of example, input devices include, but are not limited to, a keyboard, a mouse, a graphic tablet, a joystick, a light pen, a microphone, a smart phone and a scanner. An output device may be any device that enables a computer to present information to a user, and includes, but is not limited to, a video display, a printer, and an audio speaker.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

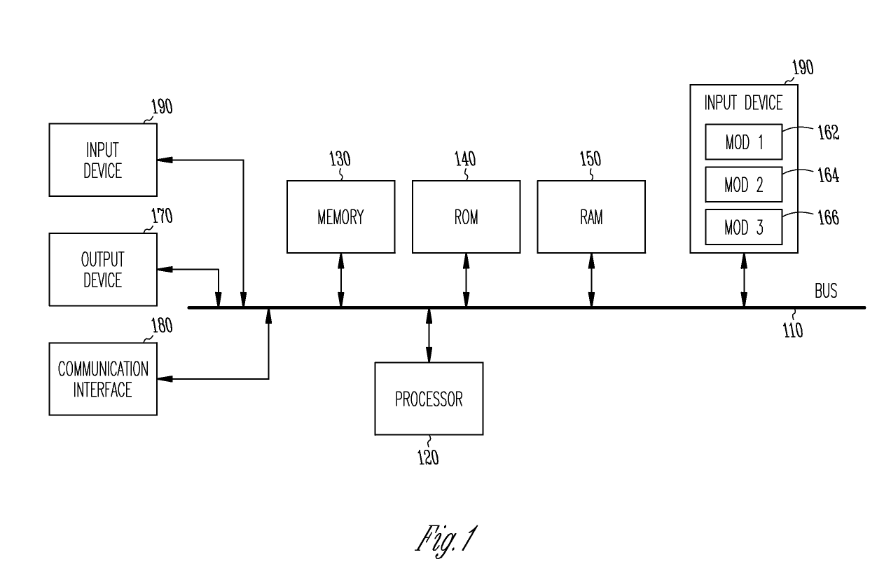

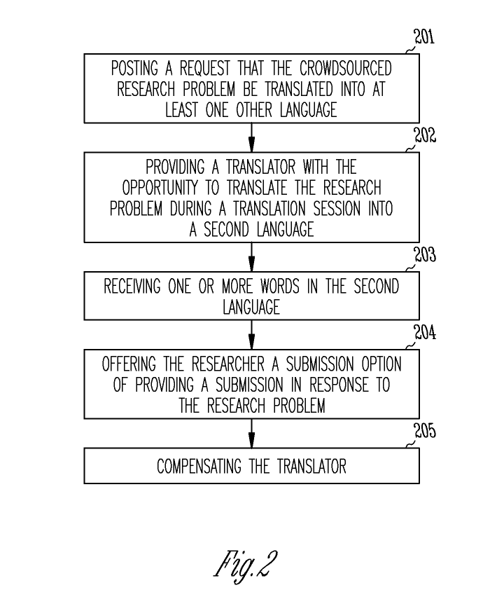

The present disclosure addresses the need in the art for translation of research problems. A system, method and non-transitory computer-readable media are disclosed for incentivizing translation of a crowdsourced research problem, said system comprising at least one processor, wherein the processor is operably coupled to a computer program product with an offering module presenting a research problem over a network in a first language. A brief introductory description with reference to FIG. 2 will be provided, followed by a discussion of a basic general purpose system or computing device in FIG. 1 which can be employed to practice the concepts disclosed herein. A more detailed description of methods and graphical interfaces will then follow.

FIG. 2 illustrates an exemplary embodiment of posting a request that the crowdsourced research problem be translated into at least one other language (201). FIG. 2 further illustrates providing a translator with the opportunity to translate the research problem during a translation session into a second language (202). The translator can submit a translation of one or more words of the research problem into the second language. Upon receipt of the one or more words in the second language, offering the researcher a submission option of providing a submission in response to the research problem (203). FIG. 2 further illustrates compensating the translator for the submission at a first compensation amount if the submission is in the second language and is relevant to the research problem and compensating the translator at a second compensation amount if the submission, alone or in combination with other submissions solves the research problem.

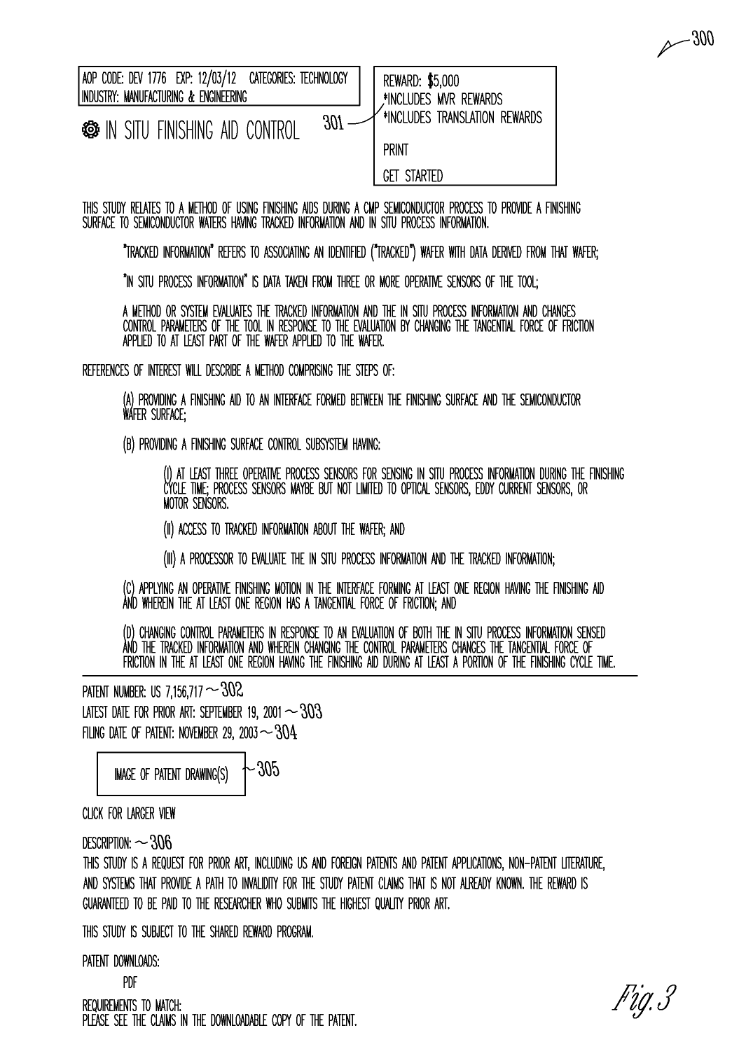

FIG. 3 illustrates an exemplary embodiment of a research problem 300. Information related to the research problem can include a patent number 302, a date for prior art search purposes 303, a filing date 304, a FIG. 305, and a description 306. Additionally, embodiments can include a reward 301 for translating the research problem.

These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache of high speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

Embodiments of the present disclosure may be implemented in non-transitory one or more electronically readable media, which when executed on a processor perform steps as described in detail above and recited by the claims below.

Unless otherwise specified, any of the features of the various embodiments described herein can be used in conjunction with features described in connection with any other embodiments disclosed. Accordingly, features described in connection with the various or specific embodiments are not to be construed as not suitable in connection with other embodiments disclosed herein unless such exclusivity is explicitly stated or implicit from the context.

The various embodiments described above are provided by way of illustration only and should not be construed to limit the scope of the disclosure. For example, the principles herein can be used to solve more effectively any number of research problems. Those skilled in the art will readily recognize various modifications and changes that may be made to the principles described herein without following the example embodiments and applications illustrated and described herein, and without departing from the spirit and scope of the disclosure.

I claim:

1. A system for incentivizing translation of a crowdsourced research problem, said system comprising at least one processor, wherein the processor is operably coupled to a computer program product with an offering module presenting a research problem over a network in a first language, wherein said computer program product comprises:
a receipt of translation module that when executed receives from a translator, data that indicates an interest in translating at least one word of the research problem into a second language, wherein the receipt of translation module offers said translator a submission option of providing a submission of a response to said research problem in said second language or other language that is different from said first language;
a receipt of submission module, wherein said receipt of submission module is configured to receive a submission from said translator when said submission option is selected;
a payment for submission module, wherein said payment for submission module is configured to compensate said translator a first compensation amount for said submission if said submission is the first submission in said second language or other language that is different from said first language and is relevant to the research problem, but does not alone or in combination with other information solve said research problem; and to compensate said translator a second compensation amount for said submission if said submission alone or in combination with other information solves said research problem; and
a payment for translation module, wherein said payment for translation module is configured to compensate said translator for said translation.

2. A system for incentivizing translation of a crowd sourced research problem, said system comprising at least one processor, wherein the processor is operably coupled to a computer program product, wherein said computer program product comprises:
an offering module, wherein the offering module presents a research problem over a network in a first language;
a receipt of translation module that when executed receives from a translator, data that indicates an interest in translating at least one word of the research problem into a second language, wherein the receipt of translation module offers said translator a submission option of providing a submission of a response to said research problem in said second or other language that is different from said first language; and
(i) a first option to translate additional words of said research problem;
(ii) a second option of providing a submission of a response to said research problem, and
(iii) a third option of exiting said receipt of translation module;
a receipt of submission module, wherein said receipt of submission module is configured to receive a submission from said translator when said second option is selected;
a payment for translation module, wherein said payment for translation module is configured to compensate said translator for said translation; and
a payment for submission module, wherein said payment for submission module is configured to compensate said translator a first compensation amount for said submission if said submission is the first submission in said second language or other language that is different from said first language and is relevant to the research problem, but does not alone or in combination with other information solve said research problem; and to compensate said translator a second compensation amount for said submission if said submission alone or in combination with other information solves said research problem.

3. The system of claim 2, wherein said offering module identifies one or more terms within said research problem as a key term or terms.

4. The system of claim 3, wherein said payment for translation module compensates said translator only for translation of a key term or terms.

5. The system of claim 2, wherein said compensation for translation comprises money.

6. The system of claim 2, wherein said compensation for translation comprises reward points.

7. The system of claim 1, wherein said first compensation amount comprises money.

8. The system of claim 2, wherein said first compensation amount comprises reward points.

9. The system of claim 2, wherein said second compensation amount comprises money.

10. The system of claim 2, wherein said second compensation amount comprises reward points.

11. The system of claim 2 further comprising a display module that when executed causes said research problem to be displayed in said second language over said network.

12. The system of claim 1, wherein the payment for translation module compensates said translator for said translation based on a monetary amount per word.

13. The system of claim 1, wherein the research problem is a request for references that alone or in combination with other references invalidates at least one patent claim.

14. The system of claim 1, wherein the network is publicly accessible.

15. A method for incentivizing a person to participate in solving a crowd sourced research problem posted in a first language on a network, said method comprising:
posting a request that the crowdsourced research problem be translated into at least one other language;
providing a translator with the opportunity to translate said research problem during a translation session into a second language, wherein said translator can submit a translation of one or more words of the research problem into said second language;
upon receipt of said one or more words in said second language, offering the researcher a submission option of providing a submission in response to the research problem; and
compensating the translator for the submission at a first compensation amount if the submission is in said second language and is relevant to said research problem and compensating the translator at a second compensation amount if the submission, alone or in combination with other submissions solves said research problem.

16. A method for incentivizing a person to participate in solving a crowdsourced research problem posted in a first language on a network, said method comprising:
posting a request that the crowdsourced research problem be translated into at least one other language;
providing a translator with the opportunity to translate said research problem during a translation session into a second language, wherein said translator can submit a translation of one or more words of the research problem into said second language;
upon receipt of said one or more words in said second language, offering the researcher a submission option of providing a submission in response to the research problem; and
compensating the translator for the submission at a first compensation amount if the submission is in said second language and is relevant to said research problem and compensating the translator at a second compensation amount if the submission, alone or in combination with other submissions solves said research problem

17. The method claim 16, wherein the research problem is a request for prior art that invalidates one or more claims of a patent.

18. The method of claim 16, wherein the first compensation amount is lower than the second compensation amount.

19. The method of claim 16 further comprising posting the said research problem in said second language on said network.

20. The method of claim 16 further comprising highlighting at least one word within said search problem as a key term.

21. The method of claim 16, wherein said compensation for translation only compensates for translation of a key term or terms.

22. The method of claim 16, wherein said compensation for translation comprises money.

23. The method of claim 16, wherein said compensation for translation comprises reward points.

24. The method of claim 15, wherein the first compensation amount comprises money.

25. The method of claim 15, wherein the second compensation amount comprises money.

26. The method of claim 16, wherein the first compensation amount comprises reward points.

27. The method of claim 16, wherein the second compensation amount comprises reward points.
